(19) United States
(12) Patent Application Publication
(10) Pub. No.: US 2026/0332048 A1
(43) Pub. Date: Oct. 22, 2026

(54) POWER SUPPLY, DEVICE INCLUDING POWER SUPPLY, AND OPERATING METHODS THEREOF

(71) Applicant: GLOBALFOUNDRIES U.S. Inc., Malta, NY (US)

(72) Inventors: Siva Kumar CHINTHU, Bangalore (IN); Pruthvi MUCHHARLA HARIPRASAD, Bangalore (IN); Rajesh Reddy TUMMURU, Bangalore (IN); Suresh PASUPULA, Anantapur (IN)

(21) Appl. No.: 19/186,224

(22) Filed: Apr. 22, 2025

(51) Int. Cl. H02M 3/07; H02M 1/00; H02M 3/00; H02M 3/155

(52) U.S. Cl. CPC H02M 3/073; H02M 1/0041; H02M 3/003; H02M 3/155

(57) ABSTRACT

A power supply includes a charge pump generating an output voltage in response to a control signal, a power bus coupled to a plurality of zones at a plurality of nodes, respectively, a controller generating the control signal to provide a supply voltage at a common level to each of the plurality of zones, and a switching device coupling one of the plurality of nodes to the controller.

### BACKGROUND

The present disclosure relates to electronic devices, more particularly, to power supply devices and operating methods thereof.

An electronic device generally incorporates a power supply to deliver a supply voltage through a conductive path to multiple components. As the supply voltage travels through the conductive path, the supply voltage decreases due to the resistance of the conductive path. Such IR drop results in varying supply voltage levels reaching different components, and thus may deteriorate the performance of the electronic device.

### SUMMARY

Embodiments of the present application relate to electronic devices, more particularly, to power supply devices and operating methods thereof.

In an embodiment, a power supply includes a charge pump configured to generate an output voltage in response to a control signal, a power bus coupled to a plurality of zones at a plurality of nodes, respectively, a controller configured to generate the control signal to provide a supply voltage at a common level to each of the plurality of zones, and a switching device configured to couple one of the plurality of nodes to the controller to form a closed-loop system.

In an embodiment, a memory device includes a plurality of zones including a plurality of zones, each of the plurality of zones including a plurality of memory cells, and a power supply configured to provide a supply voltage at a common level to each of the plurality of zones. Such a power supply includes a power supply includes a charge pump configured to generate an output voltage in response to a control signal, a power bus coupled to a plurality of zones at a plurality of nodes, respectively, a controller configured to generate the control signal to provide a supply voltage at a common level to each of the plurality of zones, and a switching device configured to couple one of the plurality of nodes to the controller to form a closed-loop system.

In an embodiment, a method of operating a power supply includes coupling, by a switching device, one of a plurality of nodes to a controller to form a closed-loop system, generating, by the controller, a control signal based on a supply voltage at the coupled node, and generating, by a charge pump, an output voltage in response to the control signal. The power supply includes the charge pump, a power bus, the controller, and the switching device, and the power bus is coupled to a plurality of zones at the plurality of nodes, respectively.

### BRIEF DESCRIPTION OF THE DRAWINGS

FIG. 1 illustrates a schematic view of an electronic device according to an embodiment.

FIG. 2 illustrates an electronic device including a power supply and a plurality of zones according to an embodiment.

FIG. 3 illustrates a charge pump according to an embodiment.

### DETAILED DESCRIPTION

A detailed description of embodiments is provided below along with accompanying figures. The scope of this disclosure is limited by the claims and encompasses numerous alternatives, modifications and equivalents. Although steps of various processes are presented in a given order, embodiments are not necessarily limited to being performed in the listed order. In some embodiments, certain operations may be performed simultaneously, in an order other than the described order, or not performed at all.

Numerous specific details are set forth in the following description. These details are provided to promote a thorough understanding of the scope of this disclosure by way of specific examples, and embodiments may be practiced according to the claims without some of these specific details. Accordingly, the specific embodiments of this disclosure are illustrative, and are not intended to be exclusive or limiting. For the purpose of clarity, technical material that is known in the technical fields related to this disclosure has not been described in detail so that the disclosure is not unnecessarily obscured.

As used herein, including in the claims, the term ‘or’ in a list of items (e.g., a list introduced by phrases such as ‘at least one of,’ ‘one or more of,’ or ‘one or both of’) is intended to be inclusive unless explicitly stated otherwise. Specifically, the term ‘or’ should be interpreted to cover any individual item in the list, any combination of items in the list, or all items in the list. For example, a phrase such as ‘at least one of A, B, or C’ is intended to encompass A alone, B alone, C alone, any combination of A and B, A and C, or B and C, as well as A, B, and C together. This inclusive interpretation applies unless an explicit indication to the contrary is provided in a particular context.

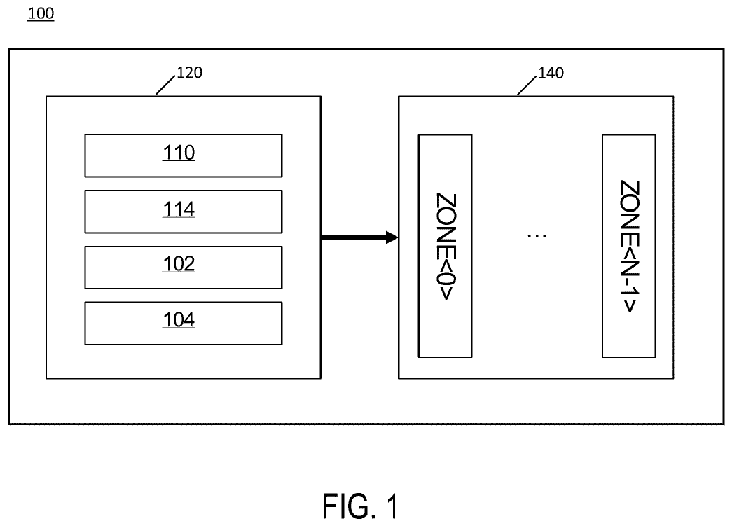

FIG. 1 illustrates a schematic view of an electronic device 100 according to an embodiment. For example, the electronic device 100 is a memory device (e.g., RRAM device, SRAM device, or M RAM device). However, embodiments of the present disclosure are not limited thereto, and the electronic device 100 may be any electronic device including a conductive path (e.g., a power bus) through which power is provided to a plurality of components coupled to the conductive path.

The electronic device 100 in FIG. 1 includes a power supply 120 and a plurality of zones 140. For example, the power supply 120 provides a supply voltage at a common level to each of the plurality of zones 140.

The power supply 120 in FIG. 1 includes a power converter (e.g., a charge pump) 110, a power bus 114, a controller 102, and a switching device 104. For example, the charge pump 110 generates an output voltage in response to a control signal, a power bus 114 is coupled to the plurality of zones ZONE <0> to ZONE <N−1> at a plurality of nodes, respectively, a controller 102 generates the control signal to provide a supply voltage at a common level to each of the plurality of zones ZONE <0> to ZONE <N−1>, and the switching device 104 couples one of the plurality of nodes to the controller 102.

The plurality of zones 140 in FIG. 1 includes a first zone ZONE <0>, a second zone ZONE <1>, . . . , and an N-th ZONE <N−1>. The plurality of zones 140 are located progressively farther from the power supply 120 in the order of the first zone ZONE <0>, the second zone ZONE <1>, . . . and the N-th ZONE <N−1>.

The power supply 120 according to an embodiment of the present disclosure provides a supply voltage at a common level to each of the plurality of zones ZONE <0> to ZONE <N−1>, regardless of a location of each the plurality of zones ZONE <0> to ZONE <N−1> relative to the power supply 120. As a result, reliability of performing an operation on a component in each of the zones ZONE <0> to ZONE <N−1> can be improved compared to a conventional device in which supply voltages to different zones vary with their locations relative to a power supply. For example, when the device 100 is a memory device, reliability of performing an operation on a memory cell in each of the plurality of zones ZONE <0> to ZONE <N−1> can be improved compared to a conventional memory device in which different locations of a plurality of zones relative to a power supply result in varying supply voltages to the plurality of zones. In some embodiments, when the device 100 is a memory device, at least one of the plurality of zones ZONE <0> to ZONE <N−1> includes not only memory cells but also one or more peripheral circuits to perform operations on the memory cells.

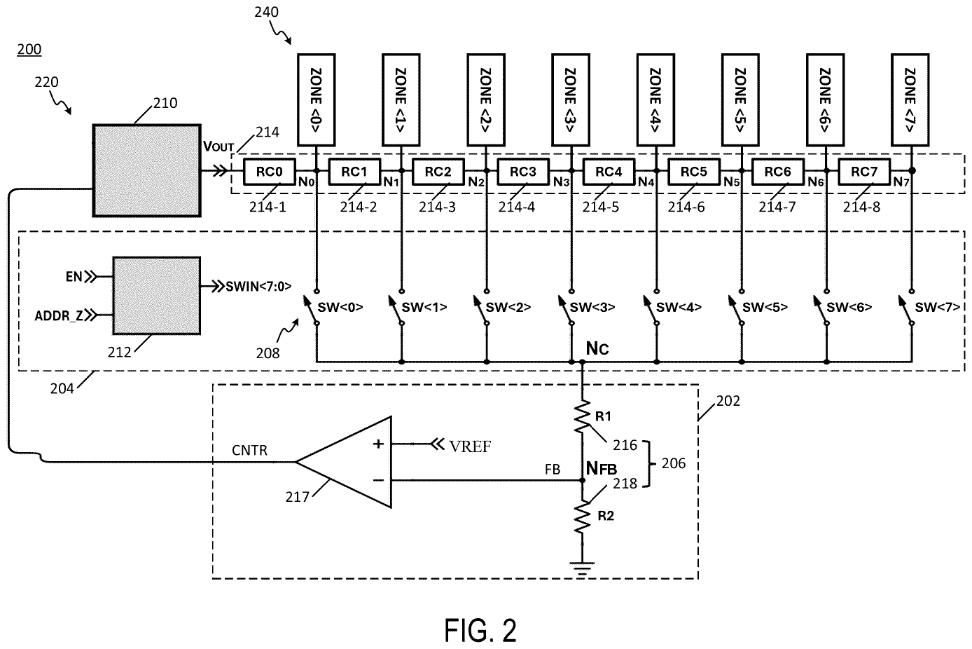

FIG. 2 illustrates an electronic device 200 (e.g., a memory device) including a power supply 220 and a plurality of zones 240 according to an embodiment of the present disclosure. In an embodiment, the power supply 220 in FIG. 2 includes a charge pump 210, a power bus 214, a controller 202, and a switching device 204.

The charge pump 210 in FIG. 2 generates an output voltage V_{OUT} in response to a control signal CNTR. In an embodiment, the charge pump 210 adjusts the output voltage V_{OUT} in response to the control signal CNTR having a first value, and maintains the output voltage V_{OUT} at a target level in response to the control signal having a second value. For example, the charge pump 210 increases the output voltage V_{OUT} in response to the control signal CNTR having a logic high value until the output voltage V_{OUT} reaches a target level, and maintains the output voltage V_{OUT} at the target level in response to the control signal CNTR having a logic low value.

The power bus 214 in FIG. 2 transmits the output voltage V OUT therethrough to provide a supply voltage to one of the plurality of zones 240. For example, the power bus 214 is coupled to first to eighth zones ZONE <0> to ZONE <7> at first to eighth nodes N₀ to N₇, respectively. The power bus 214 includes a plurality of portions 214-1 to 214-8, and a corresponding one of the plurality of nodes N₀ to N₇ is located between an adjacent pair of the plurality of portions 214-1 to 214-8.

The switching device 204 in FIG. 2 couples one of the plurality of nodes N₁ to N₈ to the controller 202. The switching device 204 includes a decoder 212 and a switching array 208.

The decoder 212 in FIG. 2 converts a zone address signal ADDR_Z indicating a specific one (or a target zone) of the plurality of zones 240-1 to 240-8 into a switching signal SWIN <7:0>. In the embodiment of FIG. 2, the decoder 212 is a 3-to-8 decoder having three input lines to receive respective values of the zone address signal ADDR_Z, an input line to receive an enable signal EN, and eight output lines to generate respective values of the switching signal SWIN <7:0>. However, embodiments of the present disclosure are not limited thereto. For example, the number of input lines and the number of output lines in the decoder 212 may vary according to embodiments.

The switching array 208 in FIG. 2 includes a plurality of switches SW <0> to SW <7>, each of which is turned on in response to the switching signal SWIN <7:0>. For example, a first switch SW <0> is turned on when a first bit (e.g., Bit 0: a least significant bit) of the switching signal SWIN <7:0> has a logic high value (e.g., 1), a second switch SW <1> is turned on when a second bit (e.g., Bit 1) of the switching signal SWIN <7:0> has a logic high value, and so on. In the embodiment of FIG. 2, each of the plurality of switches SW <0> to SW <7> has a first end coupled to a corresponding one of the plurality of nodes N₀ to N₇, and a second end coupled to a common node N_{C}.

The controller 202 in FIG. 2 includes a voltage divider 206 and a comparator 217. The voltage divider 206 in FIG. 2 generates a feedback signal (e.g., a feedback voltage) FB based on the supply voltage provided at a corresponding node Nᵢ. For example, when the third switch SW <2> is turned on while the remaining switches SW <0>, SW <1>, SW <3> . . . . SW <7> are turned off, the supply voltage V_{N2} at the third node N₂ is represented by Equation 1:

V_{N2}=V_{OUT}−I*(RC0+RC1+RC2) Equation 1,

where I is a current flowing through the first portion 214-1, the second portion 214-2, and the third portion 214-3 of the power bus 214, RC0 is resistance of the first portion 214-1, RC1 is resistance of the second portion 214-2, and RC2 is resistance of the second portion 214-2.

The voltage divider 206 in FIG. 2 includes a first resistor 216, a second resistor 218, and a feedback node NFB between the first and second resistors 216 and 218. The first resistor 216 is coupled between the common node N_{C} commonly coupled to the plurality of switches SW <0> to SW <7> and a feedback node N_{FB} at which the feedback signal is generated. The second resistors 218 is coupled between the feedback node N_{FB} and a ground. As a result, the voltage divider 206 generates the feedback voltage FB at the feedback node N_{FB} as a fraction of a voltage V N_{C} at the common node N_{C}, and thus the feedback voltage FB at the feedback node N_{FB} is represented by Equation 2:

$$FB = {V}_{NC} * \frac{R 2}{( R 1 + R 2 )} , \qquad Equation 2$$

where R1 is the resistance of the first resistor 216 and R2 is the resistance of the second resistor 218. When the third switch SW <2> is turned on, the voltage V_{NC} at the common node N_{C} is substantially equal to the supply voltage V_{N2} at the third node N₂, and thus the feedback voltage FB at the feedback node N_{FB} is represented by Equation 3:

$$FB ≅ {V}_{N 2} * \frac{R 2}{( R 1 + R 2 )} . \qquad Equation 3$$

The comparator 217 in FIG. 2 generates a control signal CNTR using the feedback signal (e.g., a feedback volage) FB and a reference signal (e.g., a reference voltage) VREF. In an embodiment, the comparator 217 compares the feedback voltage FB with the reference voltage VREF to output the control signal CNTR indicating the comparison result to the charge pump 210. For example, the comparator 204 has a first input (e.g., a positive input) receiving the reference voltage VREF and a second input (e.g., a negative input) receiving the feedback voltage FB, generates the control signal CNTR having a first logic value (e.g., a logic high value) when the reference voltage VREF is greater than the feedback voltage FB, and generates the control signal CNTR having a second logic value (e.g., a logic low value) when the reference voltage VREF is smaller than the feedback voltage VFB.

When a specific one SW <i> of the plurality of switches SW <0> to SW <7> coupled to a corresponding one Nᵢ of the nodes N₀ to N₇ is turned on, the charge pump 210, a part of the power bus 214 from the charge pump 210 to the corresponding node Nᵢ, the turned-on switch SW <i>, and the controller 202 form a closed-loop system. For example, when the first switch SW <0> is turned on while the remaining switches SW <1>, SW <2>, . . . SW <7> are turned off, the charge pump 210, a part of the power bus 214 including the first portion 214-1, the first switch SW <0>, and the controller 202 together form a first closed-loop system. Similarly, when the second switch SW <1> is turned on while the remaining switches SW <0>, SW <2>, SW <3> . . . . SW <7> are turned off, the charge pump 210, a part of the power bus 214 including the first and second portions 214-1 and 214-2, the second switch SW <1>, and the controller 202 together form a second closed-loop system.

Such a closed-loop control system operates to make the feedback voltage FB substantially equal to the reference voltage VREF, resulting in the supply voltage at a corresponding node Ni substantially equal to VREF*(R1+R2)/R2. For example, when the first switch SW <0> is turned on while the remaining switches SW <1>, SW <2>, . . . . SW <7> are turned off, the first closed-loop system makes the supply voltage V_{N0} at the first node N₀. is substantially equal to VREF*(R1+R2)/R2. Similarly, when the second switch SW <1> is turned on while the remaining switches SW <0>, SW <2>, SW <3> . . . . SW <7> are turned off, the second closed-loop system makes the supply voltage V_{N1} at the second node N₁ is substantially equal to VREF*(R1+R2)/R2, and so on. As a result, regardless of which one of the switches SW <0> to SW <7> is turned on, the power supply 220 provides substantially the supply voltage at a common level to a target zone ZONE <i> at a corresponding node Nᵢ.

As described above, the controller 202 in FIG. 2 generates the control signal CNTR to provide the supply voltage at a common level to each of the plurality of zones ZONE <0> to ZONE <7>. In an embodiment, when one of the switches SW <0> to SW <7> is turned on, the controller 202 generates the controls signal CNTR to compensate for a voltage drop (or IR drop) across a specific part of the power bus 214 between the charge pump 210 and a node N1 coupled to the turned-on switch SW <i>. For example, when the first switch SW <0> is turned on while the remaining switches SW <1>, SW <2>, . . . . SW <7> are turned off, the controller 202 adjusts the output voltage V out of the charge pump 210 to compensate for a voltage drop across the first portion 214-1 of the power bus 214 between the charge pump 210 and the first node N₀ coupled to the turned-on switch SW <0>. Specifically, the controller 202 adjusts the output voltage V_{OUT} of the charge pump 210 as represented by Equation 4:

$${V}_{OUT} = {V}_{N 0} + I * RC 0 = VREF * \frac{( R 1 + R 2 )}{R 2} + I * RC 0 , \qquad Equation 4$$

where V_{N0} is the supply voltage at the first node N₀, I is a current flowing through the first portion 214-1 of the power bus 214, and RC0 is resistance of the first portion 214-1. When the second switch SW <1> is turned on while the remaining switches SW <0>, SW <2>, SW <3> . . . . SW <7> are turned off, the controller 202 adjusts the output voltage V_{OUT} of the charge pump 210 to compensate for a voltage drop across the first portion 214-1 and the second portion 214-2 of the power bus 214 between the charge pump 210 and the second node N₁ coupled to the turned-on switch SW <1>. Specifically, the controller 202 adjusts the output voltage V out of the charge pump 210 as represented by Equation 5:

$${V}_{OUT} = {V}_{N 1} + I * ( RC 0 + RC 1 ) = VREF * \frac{( R 1 + R 2 )}{R 2} + I * ( RC 0 + RC 1 ) , \qquad Equation 5$$

where V_{N1} is the supply voltage at the second node N₁, I is a current flowing through the first portion 214-1 and the second portion 214-2 of the power bus 214, RC0 is resistance of the first portion 214-1, and RC1 is resistance of the second portion 214-2.

According to an embodiment of the present disclosure, the power supply 220 provides substantially the same supply voltage at a target level to a target zone ZONE <i> at a corresponding node Nᵢ coupled to the target zone ZONE <i>. In other words, the power supply 220 can provide the substantially same supply voltage to the target zone ZONE <i> regardless of a distance from the charge pump 210. For example, when an operation (e.g., a programming operation) is performed on a memory cell in the target zone ZONE <i>, the operation can be performed using the same supply voltage regardless of whether the target zone ZONE <i > is a far zone or a near zone relative to the charge pump 210, thereby improving reliability of the memory device 200 (e.g., reducing bit error rate).

In addition, according to an embodiment of the present disclosure, the power supply 220 includes the switching device 204 with the decoder 212 and the plurality of switches SW <0> to SW <7> to form a closed-loop system when each of the switches SW <0> to SW <7> is turned on. The decoder 212 and the switches SW <0> to SW <7> in the electronic device 200 according to an embodiment of the present disclosure may consume a relatively small circuit area compared to a conventional device incorporating a relatively thick conductive path to reduce its resistance to reduce IR drops through the conductive path.

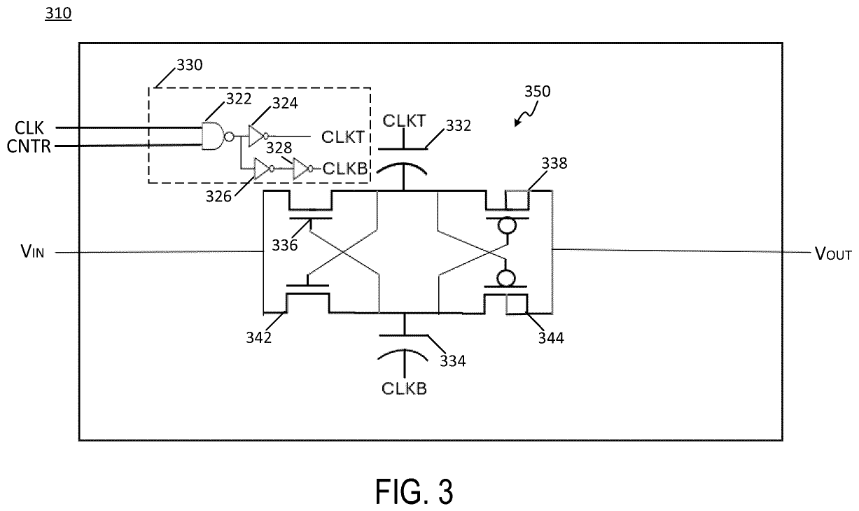

FIG. 3 illustrates a charge pump 310 suitable for use as the charge pump 210 in FIG. 2, according to an embodiment. The charge pump 310 in FIG. 3 generates an output voltage V_{OUT} in response to a control signal CNTR from a controller (e.g., the controller 202 in FIG. 2). For example, the charge pump 310 includes a clock control circuit 330 and a charge pump core 350.

The clock control circuit 330 in FIG. 3 activates the charge pump core 350 in response to a clock signal CLK and the control signal CNTR. In an embodiment, the clock control circuit 330 generates a first clock signal CLKT and a second clock signal CLK B to activate the charge pump core 350 to increase the output voltage V out, when the control signal CNTR has a given value. For example, the control circuit 330 generates the first clock signal CLKT that is substantially the same as the clock signal CLK and the second clock signal CLK B that is an inverted version of the first clock signal CLKT, when the control signal CNTR has a logic high value. The clock control circuit 330 in FIG. 3 includes a first logic gate (e.g., a NAND gate) 322, a second logic gate (e.g., an inverter) 324, a third logic gate 326 (e.g., an inverter), and a fourth logic gate (e.g., an inverter) 328.

The charge pump core 350 in FIG. 3 includes first, second, third, and fourth transistors 336, 338, 342, and 344, a first capacitor 332, and a second capacitor 334. For example, each of the first and third transistors 336 and 342 is an NM OS transistor, and each of the second and fourth transistors 338 and 344 is a PM OS transistor.

The charge pump core 350 in FIG. 3 adjusts the output voltage V out when the charge pump core 350 is activated in response to the control signal CNTR having a given value (e.g., a logic high value). Specifically, during a first half cycle (e.g., CLKT has a logic low value and CLK B has a logic high value), the first transistor 336 is turned on to charge the first capacitor 332 and the fourth transistor 344 is turned on to discharge the second capacitor 334. During a second half cycle (e.g., CLKT has a logic high value and CLKB has a logic low value), the third transistor 342 is turned on to charge the second capacitor 334 and the second transistor 338 is turned on to discharge the first capacitor 332. As a result, when the charge pump core 350 is activated in response to the control signal CNTR, a voltage gain is obtained to increase the output voltage V_{OUT}.

A device according to an embodiment of the present disclosure includes a power supply providing substantially the same supply voltage to each of a plurality of zones. As a result, reliability of performing an operation on a component in each a plurality of zones can be improved compared to a conventional device in which supply voltages to different regions vary with their locations relative to a power supply.

A power supply according to an embodiment of the present disclosure includes a switching device having a decoder and a plurality of switches to form a closed-loop system when each of the switches is turned on. Such a closed-loop system compensates for a voltage drop across a specific part of a power bus between a charge pump and a node, when the node is coupled to a controller by the turned-on switch. The decoder and the switches may consume a relatively small circuit area compared to a conventional device incorporating a relatively thick conductive path to reduce its resistance to reduce IR drops through the conductive path.

A method of operating a power supply according to an embodiment of the present disclosure includes: coupling, by a switching device (e.g., the switching device 204 in FIG. 2), one of a plurality of nodes (e.g., the nodes N₀ to N₇ in FIG. 2) to a controller (e.g., the controller 202 in FIG. 2) to form a closed-loop system; generating, by the controller, a control signal (e.g., the control signal CNTR in FIG. 2) based on a supply voltage at the coupled node; and generating, by a charge pump (e.g., the charge pump 210 in FIG. 2), an output voltage (e.g., the output voltage V_{OUT} in FIG. 2) in response to the control signal. In some embodiments, generating the control signal includes generating a feedback signal (e.g., the feedback signal FB in FIG. 2) based on the supply voltage at the coupled node and generating the control signal using the feedback signal and a reference signal (e.g., the reference signal VREF in FIG. 2). In some embodiments, the method further includes turning on each of a plurality of switches (e.g., the switches SW <0> to SW <7> in FIG. 2) of the switching device in response to a switching signal (e.g., the switching signal SWIN <7:0> in FIG. 2).

Aspects of the present disclosure have been described in conjunction with the specific embodiments thereof that are proposed as examples. Numerous alternatives, modifications, and variations to the embodiments as set forth herein may be made without departing from the scope of the claims set forth below. Accordingly, embodiments as set forth herein are intended to be illustrative and not limiting.

1. A power supply, comprising:
a charge pump configured to generate an output voltage in response to a control signal;
a power bus coupled to a plurality of zones at a plurality of nodes, respectively;
a controller configured to generate the control signal to provide a supply voltage at a common level to each of the plurality of zones; and
a switching device configured to couple one of the plurality of nodes to the controller to form a closed-loop system.

2. The power supply of claim 1, wherein the coupled node provides the supply voltage to a corresponding one of the plurality of zones, and
wherein the closed-loop system compensates for a voltage drop across a specific part of the power bus, the specific part of the power bus between the charge pump and the coupled node.

3. The power supply of claim 2, wherein the controller generates a feedback signal based on the supply voltage at the coupled node, and generates the control signal using the feedback signal and a reference signal.

4. The power supply of claim 3, wherein the controller includes a voltage divider configured to generate the feedback signal as a fraction of the supply voltage at the coupled node and a comparator configured to compare the feedback signal with the reference signal to output the control signal to the charge pump.

5. The power supply of claim 4, wherein the voltage divider includes a first resistor and a second resistor, the first resistor is coupled between a common node commonly coupled to a plurality of switches of the switching device and a feedback node at which the feedback signal is generated, and the second resistor is coupled between the feedback node and a ground.

6. The power supply of claim 1, wherein the switching device includes a plurality of switches and turns on each of the plurality of switches in response to a switching signal.

7. The power supply of claim 6, wherein the switching device further includes a decoder configured to covert a zone address signal into the switching signal, the zone address signal indicating a corresponding one of the plurality of zones.

8. The power supply of claim 6, wherein each of the plurality of switches has a first end coupled to a corresponding one of the plurality of nodes and a second end coupled to a common node.

9. The power supply of claim 1, wherein the charge pump adjusts the output voltage in response to the control signal having a first value, and maintains the output voltage at a target level in response to the control signal having a second value.

10. The power supply of claim 9, wherein the charge pump includes a clock control circuit and a charge pump core, and the clock control circuit is configured to activate the charge pump core in response a clock signal and the control signal having the first value to increase the output voltage of the charge pump.

11. A memory device, comprising:
a plurality of zones including a plurality of zones, each of the plurality of zones including a plurality of memory cells; and
a power supply configured to provide a supply voltage at a common level to each of the plurality of zones,
wherein the power supply includes:
a charge pump configured to generate an output voltage in response to a control signal;
a power bus coupled to the plurality of zones at a plurality of nodes, respectively;
a controller configured to generate the control signal; and
a switching device configured to couple one of the plurality of nodes to the controller to form a closed-loop system.

12. The device of claim 11, wherein at least one of the plurality of zones further includes one or more peripheral circuits.

13. The device of claim 11, wherein the coupled node provides the supply voltage to a corresponding one of the plurality of zones, and
wherein the closed-loop system compensates for a voltage drop across a specific part of the power bus, the specific part of the power bus between the charge pump and the coupled node.

14. The device of claim 13, wherein the controller generates a feedback signal based on the supply voltage at the coupled node, and generates the control signal using the feedback signal and a reference signal.

15. The device of claim 11, wherein the switching device includes a plurality of switches and turns on each of the plurality of switches in response to a switching signal.

16. The device of claim 11, wherein the charge pump adjusts the output voltage in response to the control signal having a first value, and maintains the output voltage at a target level in response to the control signal having a second value.

17. A method of operating a power supply, wherein the power supply includes a charge pump, a power bus, a controller, and a switching device, the power bus coupled to a plurality of zones at a plurality of nodes, respectively, the method comprising:
coupling, by the switching device, one of the plurality of nodes to the controller to form a closed-loop system;
generating, by the controller, a control signal based on a supply voltage at the coupled node; and
generating, by the charge pump, an output voltage in response to the control signal.

18. The method of claim 17, wherein the coupled node provides the supply voltage to a corresponding one of the plurality of zones,
wherein the closed-loop system compensates for a voltage drop across a specific part of the power bus, the specific part of the power bus between the charge pump and the coupled node.

19. The method of claim 18, wherein generating the control signal includes:
generating a feedback signal based on the supply voltage at the coupled node; and
generating the control signal using the feedback signal and a reference signal.

20. The method of claim 17, wherein the switching device includes a plurality of switches, the method further comprising turning on each of the plurality of switches in response to a switching signal.
